(19) United States
(12) Patent Application Publication
(10) Pub. No.: US 2013/0301110 A1
(43) Pub. Date: Nov. 14, 2013

(54) ELECTROWETTING DISPLAY APPARATUS AND DYE COMPOSITION FOR ELECTORWETTING DISPLAY

(71) Applicant: FUJIFILM CORPORATION, Tokyo (JP)

(72) Inventors: Takashi KATO, Fujinomiya-shi (JP); Satoshi HIGUCHI, Fujinomiya-shi (JP)

(73) Assignee: FUJIFILM CORPORATION, Tokyo (JP)

(21) Appl. No.: 13/890,263

(22) Filed: May 9, 2013

(30) Foreign Application Priority Data
May 10, 2012 (JP) 2012-108404
Mar. 15, 2013 (JP) 2013-054289

(51) Int. Cl. C09B 67/46; G02B 26/00

(52) U.S. Cl. CPC C09B 67/0089; G02B 26/005
USPC 359/290; 516/198; 516/204

(57) ABSTRACT

An electrowetting display apparatus is provided, which has a display unit including: a first substrate at least one surface of which is electroconductive; a second substrate arranged to face the electroconductive surface of first substrate; a hydrophobic insulation film arranged on the electroconductive surface of first substrate; a non-electroconductive oil provided between the hydrophobic insulation film and second substrate movably on the hydrophobic insulation film and containing a nonpolar solvent, a dye in a content of 10 mass % or higher with respect to the total mass of oil, and a nonionic surfactant; and an electroconductive hydrophilic liquid provided between the hydrophobic insulation film and second substrate so as to contact the oil; wherein an image is displayed by applying a voltage between the hydrophilic liquid and electroconductive surface of first substrate for changing the shape of an interface between the oil and hydrophilic liquid.

### CROSS-REFERENCE TO RELATED APPLICATION

This application claims priority under 35 USC 119 from Japanese Patent Application No. 2012-108404 filed on May 10, 2012, and Japanese Patent Application No. 2013-054289 filed on Mar. 15, 2013, the disclosures of which are incorporated by reference herein.

### BACKGROUND OF THE INVENTION

1. Field of the Invention

The present invention relates to an electrowetting display apparatus and a dye composition for electrowetting display.

2. Description of the Related Art

Optical devices have been investigated, which are each equipped with a cell containing two or more kinds of liquids that are not miscible with each other (for example, the two liquids being an oil and a hydrophilic liquid), and which are operated (or driven) by application of a voltage. Examples of such optical devices that are well-known include an optical shutter, a varifocal lens, an image display apparatus, and the like. In particular, a technology utilizing an electrowetting phenomenon has garnered attention recently.

As an example of the technology utilizing an electrowetting phenomenon, an electrowetting display provided with a first substrate and a second substrate that are placed opposite to each other, plural projections defining plural pixel units, a non-electroconductive first fluid contained in a pixel unit between two adjacent projections, and a second fluid, which is not miscible with the first fluid and is an electroconductive or polar liquid, has been disclosed (for example, see Japanese Patent Application Laid-Open (JP-A) No. 2009-86668).

Further, a technology in which a cationic or anionic surfactant is contained in a liquid that is a component of an electrowetting device has been disclosed (for example, see International Publication (WO) No. 2008/142086).

Further, an emulsion ink which contains a low-molecular-weight nonionic surfactant and in which a hydrophobic liquid is dispersed in a hydrophilic liquid has been disclosed, and it has been disclosed that a problem of injection (dropping) can be solved by using the emulsion (for example, see JP-A No. 2012-68507). The amount of a coloring material contained in the emulsion ink is relatively small and there are concerns about the image density.

### SUMMARY OF THE INVENTION

As described above, an electrowetting display is one of the display technologies that have garnered attention recently as an image display medium. Moreover, as a display medium that can replace a paper medium or the like, the electrowetting display is required to have such properties as display speed in displaying an image, and favorable density, discernibility and high-definition of a displayed image.

Among various properties, requirements for display speed (namely, image formation property) and discernibility and high-definition of a displayed image are stringent.

In order to develop sufficient density of an image displayed by an electrowetting display, the concentration of an oil responsible for forming an image, namely the concentration of a coloring material contained in the oil, is required to be increased. In general, dyes are used as a coloring material in an oil. However, dyes sometimes have poor solubility in a nonpolar solvent constituting an oil phase, and therefore it is difficult to increase the concentration of the coloring material to a level suitable for an image display, while maintaining good display properties.

Meanwhile, in a case in which a dye having a high solubility in a nonpolar solvent is used, the color density of the oil itself is increased. However, if the dye amount is too large, the operating sensitivity (responsiveness) of the oil in response to a voltage applied is decreased, and the image formation property tends to deteriorate significantly.

Consequently, in order to keep the image displaying properties of a display at reasonable levels, the image quality has had to be sacrificed. In other words, a technology enabling both favorable image displaying properties (namely, image formation properties such as displaying speed) and image quality has not yet been established.

The present invention has been made under such circumstances. The present invention aims to provide an electrowetting display apparatus and a dye composition for electrowetting display, which enable display of an image with a favorable density, attainment of excellent responsiveness at the time of displaying an image, and prevention of image disturbance caused by a backflow phenomenon.

The inventors of the present invention have found that the responsiveness of an oil phase that contributes to image formation when the dye concentration therein is relatively higher is not improved in a case in which, among various surfactants, an ionic surfactant such as a cationic or anionic surfactant is used. Furthermore, the inventors have found that the improvement effect is specifically attained when a nonionic surfactant is selectively used, and that an improvement effect on a backflow phenomenon in a state of being kept under application of a voltage can also be expected. From these findings, the present invention has been made.

Examples of specific embodiments of the present invention are described below.

[1] An electrowetting display apparatus including a display unit, the display unit including:

a first substrate at least one surface of which is at least partly electroconductive;

a second substrate arranged so as to face the at least partly electroconductive surface of the first substrate;

a hydrophobic insulation film placed on at least a part of the at least partly electroconductive surface of the first substrate;

a non-electroconductive oil which is provided between the hydrophobic insulation film and the second substrate movably on the hydrophobic insulation film and includes a nonpolar solvent, a dye at a content of 10 mass % or higher with respect to the total mass of the oil, and a nonionic surfactant; and

an electroconductive hydrophilic liquid provided between the hydrophobic insulation film and the second substrate so as to contact the oil,

wherein an image is displayed by applying a voltage between the hydrophilic liquid and the electroconductive surface of the first substrate and changing the shape of an interface between the oil and the hydrophilic liquid.

[2] The electrowetting display apparatus according to [1], wherein the content of the dye exceeds 20 mass % with respect to the total mass of the oil.

[3] The electrowetting display apparatus according to [1] or [2], wherein the nonionic surfactant is a compound including an ethyleneoxy chain or a propyleneoxy chain in a molecule thereof.

[4] The electrowetting display apparatus according to any one of [1] to [3], wherein the nonionic surfactant is a compound including an ethyleneoxy chain represented by (CH₂CH₂O)ₙ, wherein n represents an integer from 4 to 20.

[5] The electrowetting display apparatus according to any one of [1] to [4], wherein the dye has a structure including a long-chain alkyl group having 6 to 30 carbon atoms.

[6] The electrowetting display apparatus according to any one of [1] to [5], wherein the dye is selected from the group consisting of an azo dye, an azomethine dye, a methine dye, a phthalocyanine dye, and an anthraquinone dye.

[7] A dye composition for electrowetting display, including:

a nonpolar solvent;

a dye at a content of 10 mass % or higher with respect to the total mass of the dye composition; and

a nonionic surfactant.

[8] The dye composition for electrowetting display according to [7], wherein the content of the dye exceeds 20 mass % with respect to the total mass of the dye composition.

[9] The dye composition for electrowetting display according to [7] or [8], wherein the nonionic surfactant is a compound including an ethyleneoxy chain or a propyleneoxy chain in a molecule thereof

[10] The dye composition for electrowetting display according to any one of [7] to [9], wherein the nonionic surfactant is a compound including an ethyleneoxy chain represented by (CH₂CH₂O)ₙ, wherein n represents an integer from 4 to 20.

[11] The dye composition for electrowetting display according to any one of [7] to [10], wherein the dye has a structure including a long-chain alkyl group having 6 to 30 carbon atoms.

The present invention provides an electrowetting display apparatus and a dye composition for an electrowetting display, which enable an image display with high density, are also superior in the responsiveness in displaying an image, and prohibit image disturbance by a backflow phenomenon.

### BRIEF DESCRIPTION OF THE DRAWINGS

FIG. 1 is a schematic sectional view of an electrowetting display apparatus according to an embodiment of the present invention in a voltage-off state.

FIG. 2 is a schematic sectional view of an electrowetting display apparatus according to an embodiment of the present invention in a voltage-on state.

FIG. 3 is a graph showing an influence of addition of a nonionic surfactant in the absence of a dye on the responsiveness.

FIG. 4 is a graph showing an influence of addition of a nonionic surfactant in the presence of a dye on the responsiveness.

### DETAILED DESCRIPTION OF THE INVENTION

Embodiments of an electrowetting display apparatus will be described below in details by referring to the drawings, and therethrough a dye composition for electrowetting display will be also described in details. However, the present invention is not limited to the following embodiments.

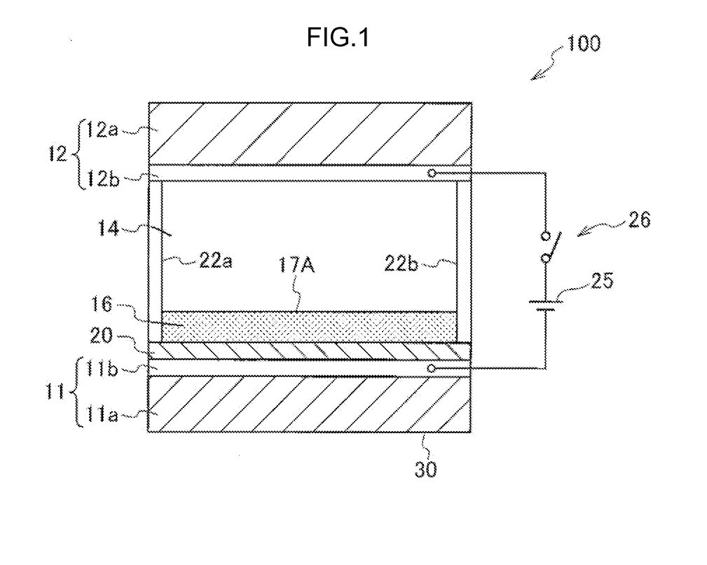

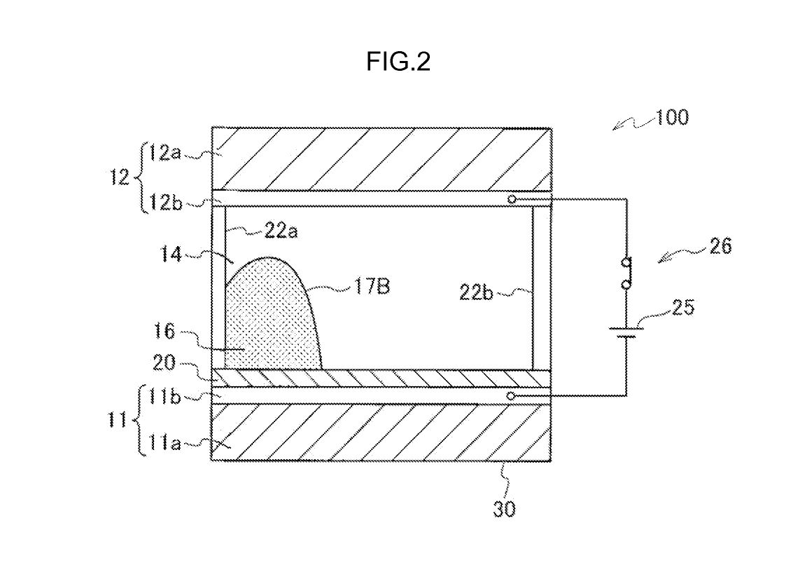

A first embodiment of an electrowetting display apparatus according to the present invention will be described by referring to FIG. 1 and FIG. 2. The first embodiment has a configuration in which an ITO-coated glass substrate is used as an electroconductive first substrate, decane is used as a nonpolar solvent that constitutes an oil, and an aqueous electrolyte solution is used as a hydrophilic liquid.

As shown in FIG. 1, an electrowetting display apparatus 100 of the present embodiment has at least: an electroconductive substrate (i.e., first substrate) 11; an electroconductive substrate (i.e., second substrate) 12 arranged so as to face the substrate 11; a hydrophobic insulation film 20 placed on the substrate 11; and a hydrophilic liquid 14 and an oil 16 which are charged in a region partitioned by a silicone rubber wall 22a and a silicone rubber wall 22b between the hydrophobic insulation film 20 and the substrate 12. The region partitioned by the silicone rubber wall 22a and the silicone rubber wall 22b between the hydrophobic insulation film 20 and the substrate 12 serves as a display unit (i.e., display cell) which is capable of displaying an image in accordance with a movement of the oil 16.

According to various previous studies concerning a technology of electrowetting, when the color density is to be increased in order to improve the quality of a display image, the responsiveness in response to the application of voltage tends to decrease, and the backflow under voltage application tends to deteriorate. Meanwhile, a technology has been known, by which a cationic or anionic surfactant is used as a component in a liquid composition to be used in a technology of electrowetting. However, with such an ionic surfactant, if the dye concentration is increased from a viewpoint of enhancing the contrast ratio of a display image, etc., an improvement effect on the responsiveness or the backflow under voltage application cannot be expected. On the other hand according to the present invention, even when the dye percentage is increased and a formulation is similar to the formulation in which the responsiveness tends to decrease, the responsiveness and the backflow under voltage application are specifically improved by selectively using a nonionic surfactant.

The substrate 11 includes a substrate material 11a and an electroconductive film 11b (for example, an ITO film) which has electroconductivity, is arranged on the substrate material 11a, and has a configuration in which the entire substrate surface exhibits electroconductivity. The substrate 12 is arranged at a location facing the substrate 11. Similarly to the substrate 11, the substrate 12 includes a substrate material 12a and an electroconductive film 12b (for example, an ITO film) which has electroconductivity, is arranged on the substrate material 12a, and has a configuration in which the entire substrate surface exhibits electroconductivity. In the present embodiment, the substrate 11 and the substrate 12 are each formed from a transparent glass substrate and a transparent ITO film provided thereon.

The substrate material 11a and the substrate material 12a may be formed using either a transparent material or a non-transparent material, depending on the display mode of the apparatus. From a viewpoint of displaying an image, it is preferable that at least one of the substrate material 11a or the substrate material 12a has optical transparency. Specifically, at least one of the substrate material 11a or the substrate material 12a has preferably a transmittance of 80% or higher, and more preferably 90% or higher, in the entire wavelength range from 380 nm to 770 nm.

Examples of the materials used for the substrate material 11a and substrate material 12a include a glass substrate such as an alkali-free glass substrate, a soda glass substrate, a PYREX (registered trademark) glass substrate, or a quartz glass substrate; a plastic substrate such as a polyethylene naphthalate (PEN) substrate, a polyethylene terephthalate (PET) substrate, a polycarbonate (PC) substrate, or a polyimide (PI) substrate; a metal substrate such as an aluminum substrate or a stainless steel substrate; and a semiconductor substrate such as a silicon substrate. Among these, from a viewpoint of optical transparency, a glass substrate or a plastic substrate is preferable.

Further, as a substrate material, a TFT substrate provided with a thin-film transistor (TFT) may be used. In this case, a mode in which an electroconductive film is connected to the TFT, namely, a mode in which the electroconductive film is a pixel electrode connected with the TFT, is favorable. By this means, a voltage can be applied independently to each pixel, and active drive of the entire image display apparatus can be made similarly as in a known liquid crystal display apparatus provided with a TFT.

The arrangement of a TFT, various wirings, storage capacitors, and the like in the TFT substrate may be as a known arrangement, and, for example, the arrangement described in Japanese Patent Application Laid-Open (JP-A) No. 2009-86668 may be referred to.

The electroconductive film 11b and the electroconductive film 12b may be either a transparent film or a non-transparent film, depending on the display mode of the apparatus. An electroconductive film means a film having electroconductivity, and the electroconductivity means such an electric conducting property as enables application of a voltage, and specifically to have a surface resistance of 500 Ω/sq or less, preferably 70 Ω/sq or less, more preferably 60 Ω/sq or less, and further preferably 50 Ω/sq or less.

The electroconductive film may be either of a non-transparent metal film such as a copper film or a transparent film, but a transparent electroconductive film is preferable from a viewpoint of imparting optical transparency for image display. A transparent electroconductive film preferably has a transmittance of 80% or higher, and more preferably 90% or higher, over the entire wavelength range from 380 nm to 770 nm. Examples of a transparent electroconductive film include films containing at least one of indium tin oxide (ITO), indium zinc oxide (IZO), tin oxide, indium oxide, zirconium oxide, zinc oxide, cadmium oxide, or magnesium oxide. Among these, a film containing indium tin oxide (ITO) is preferable as a transparent electroconductive film, in terms of optical transparency and electroconductivity.

The amount of tin oxide in an ITO-containing film is preferably in a range from 5 mass % to 15 mass %, and more preferably in a range from 8 mass % to 12 mass %, from a viewpoint of lowering the resistance value.

There is no particular restriction on the specific resistance of an electroconductive film, and it may be, for example, 1.0×10⁻³ Ω·cm or less.

In a preferable embodiment, an electrical potential common to plural display cells constituting display pixels is applied to the electroconductive film 12b of the substrate 12, while an independent electrical potential with respect to each display pixel (display cell) is applied to an electroconductive film 11b of the substrate 11, such that an independent voltage is applied to each display cell (pixel). With respect to such an embodiment, known modes for a liquid crystal display apparatus may be referred to.

In the present embodiment, the substrate 12 is provided as an electroconductive substrate similarly to the substrate 11. However, an embodiment in which the substrate 12 has no electroconductive film and is not electroconductive, and a voltage is applied between the electroconductive film 11b and the hydrophilic liquid 14, may also employed. In this case, there is no particular restriction on the configuration of the substrate 12, and the materials which may be used for the substrate material 12a as mentioned above may be used.

The hydrophobic insulation film 20 is provided over the entire surface of the electroconductive film 11b of the substrate 11 and contacts at least the oil 16. The hydrophobic insulation film is in a state in which it contacts mainly the oil, when a voltage is not applied (i.e., image non-display stage). When a voltage is applied (i.e., image display stage), the oil moves on the surface of the insulation film, and a region on the hydrophobic insulation film 20 where the oil becomes absent comes into a state of contacting the hydrophilic liquid.

The hydrophobicity means a property with which the contact angle with respect to water exhibits 60° or higher, preferably 70° or higher, and more preferably 80° or higher, when water is contacted.

The contact angle may be measured by a general method of measuring wettability of a glass substrate, such as a method described in JIS R3257 “Testing Method of Wettability of Glass Substrate; 6. Sessile Drop Method”. Specifically, the contact angle may be measured in such a manner that: using a contact angle meter (for example, CONTACT ANGLE METER CA-A (trade name), manufactured by Kyowa Interface Science Co., Ltd.), a waterdrop in a size of 20 scale units is formed, and extruded through a needle to contact a hydrophobic insulation film to form a waterdrop thereon, and after being left standing for 10 sec, the profile of the waterdrop is observed through an inspection hole of the contact angle meter to obtain the contact angle 0 (25° C.).

The “insulation” of an insulation film means a property, with which the specific resistance is 10⁷ Ω·cm or higher, and the specific resistance is preferably 10⁸ Ω·cm or higher, more preferably 10⁹ Ω·cm or higher.

As a hydrophobic insulation film, an insulation film having affinity with the oil 16 and has a low affinity with the hydrophilic liquid 14 may be used, and from a viewpoint of suppression of film deterioration caused by movements of the oil by repeated application of a voltage, a film having a cross-linked structure derived from a polyfunctional compound is preferable. In particular, the hydrophobic insulation film is preferably a film having a cross-linked structure derived from a polyfunctional compound having 2 or more polymerizable groups. The cross-linked structure may be favorably formed by polymerizing at least one polyfunctional compound, and, if necessary, another monomer.

In the present embodiment, the film is formed from a copolymer obtained by copolymerization of a 5-membered cyclic perfluorodiene.

The polyfunctional compound is a compound having 2 or more polymerizable groups in a molecule. Examples of polymerizable groups include a radical-polymerizable group, a cation-polymerizable group, and a condensation-polymerizable group. Among them, a (meth)acryloyl group, an allyl group, an alkoxysilyl group, an α-fluoroacryloyl group, an epoxy group, a —C(O)OCH═CH₂ group, and the like are preferable. Further, the two or more polymerizable groups contained in the polyfunctional compound may be the same or different from each other.

For forming a cross-linked structure, polyfunctional compounds may be used singly or in combination of two or more thereof.

As the polyfunctional compound, known polyfunctional polymerizable compounds, such as a radical-polymerizable group, a cation-polymerizable group, or a condensation-polymerizable group, may be used. Examples of polyfunctional compounds include polyfunctional acrylates such as ethylene glycol di(meth)acrylate, diethylene glycol di(meth)acrylate, polyethylene glycol di(meth)acrylate, 1,6-hexanediol di(meth)acrylate, ethoxylated 1,6-hexanediol diacrylate, neopentylglycol di(meth)acrylate, ethoxylated neopentylglycol di(meth)acrylate, propoxylated neopentylglycol di(meth)acrylate, tripropylene glycol di(meth)acrylate, polypropylene glycol diacrylate, 1,4-butanediol di(meth)acrylate, 1,9-nonanediol diacrylate, tetraethylene glycol diacrylate, 2-n-butyl-2-ethyl-1,3-propanediol diacrylate, dimethylol-tricyclodecane diacrylate, hydroxypivalate neopentylglycol diacrylate, 1,3-butyleneglycol di(meth)acrylate, ethoxylated bisphenol A di(meth)acrylate, propoxylated bisphenol A di(meth)acrylate, cyclohexane dimethanol di(meth)acrylate, dimethyloldicyclopentane diacrylate, trimethylolpropane triacrylate, ethoxylated trimethylolpropane triacrylate, propoxylated trimethylolpropane triacrylate, pentaerythritol triacrylate, tetramethylolpropane triacrylate, tetramethylolmethane triacrylate, pentaerythritol tetraacrylate, caprolactone-modified trimethylolpropane triacrylate, ethoxylated isocyanuric acid triacrylate, tri(2-hydroxyethyl isocyanurate)triacrylate, propoxylated glyceryl triacrylate, tetramethylolmethane tetraacrylate, pentaerythritol tetraacrylate, ditrimethylolpropane tetraacrylate, ethoxylated pentaerythritol tetraacrylate, dipentaerythritol hexaacrylate, neopentylglycol oligoacrylate, 1,4-butanediol oligoacrylate, 1,6-hexanediol oligoacrylate, trimethylolpropane oligoacrylate, pentaerythritol oligoacrylate, urethane acrylate, epoxy acrylate, or polyester acrylate.

As the polyfunctional compound, polyfunctional polymerizable compounds other than those mentioned above may be used, and examples of other polymerizable compounds known polyfunctional polymerizable compounds described in Paragraphs 0031 to 0035 of JP-A No. 2008-181067, Paragraphs 0149 to 0155 of JP-A No. 2008-139378, Paragraphs 0142 to 0146 of JP-A No. 2010-134137, or the like.

The polyfunctional compound has preferably 3 or more, more preferably 4 or more, and further preferably 5 or more polymerizable groups in a molecule. By this configuration, the density of the cross-linked structure in a film is further increased, and therefore the deterioration of a hydrophobic insulation film which may be caused by repeated application of a voltage is further suppressed.

As a polyfunctional compound, a fluorine-containing compound is preferable, and a polyfunctional compound having a fluorine content of 35 mass % or higher, preferably 40 mass % or higher, and more preferably 45 mass % or higher, with respect to the molecular weight is preferable. When the polyfunctional compound contains a fluorine atom (especially, when the fluorine content with respect to the molecular weight is 35 mass % or higher), the hydrophobicity of the hydrophobic insulation film is improved. Although there is no particular restriction on the upper limit of the fluorine content in a polyfunctional compound, the upper limit of the fluorine content with respect to the molecular weight may be, for example, 60 mass %, preferably 55 mass %, and more preferably 50 mass-%.

Examples of a fluorine-containing compound as a polyfunctional compound include the fluorine-containing compounds described in Paragraphs 0007 to 0032 of JP-A No. 2006-28280.

The polymerization method for the polyfunctional compound is preferably bulk polymerization or solution polymerization.

Examples of a polymerization initiation method include a method using a polymerization initiator (for example, a radical initiator), a method of irradiation with light or radiation, a method of addition of an acid, a method of addition of a photoacid generator followed by irradiation with light, and a method of heating for dehydration condensation. Such polymerization methods and polymerization initiation methods are described, for example, in “Kobunshi Gosei Houhou (Macromolecule Synthesis Method)” (revised version), written by Tsuruta Teiji, Nikkan Kogyo Shinbun, Ltd., 1971, and “Kobunshi Gosei no Jikken-hou (Experimental Method for Macromolecule Synthesis)”, co-written by Otsu Takayuki and Kinoshita Masayoshi, Kagaku-Dojin Publishing Company, Inc., 1972, p. 124 to 154.

The hydrophobic insulation film may be favorably formed using a curable composition containing the polyfunctional compound. The curable composition may contain one kind, or two or more kinds of the polyfunctional compounds, and the curable composition may further contain a monofunctional compound. As the monofunctional compound, any one of known monofunctional monomers may be used.

There is no particular restriction on the content (or the total content when two or more polyfunctional compounds are used; the same applies to the description hereinbelow) of the polyfunctional compound in the curable composition. However, from a viewpoint of the curing property, the content (or the total content) is preferably 30 mass % or higher, more preferably 40 mass % or higher, and particularly preferably 50 mass % or higher, with respect to the total solid in the curable composition. The total solid means the total components other than a solvent.

It is preferable that the curable composition further contain at least one solvent. Examples of the solvent include ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, 1-butanol, propylene glycol monomethyl ether, propylene glycol monomethyl ether acetate, cyclohexanone, cyclohexanol, ethyl lactate, methyl lactate, and caprolactam.

The content of a solvent (or the total content when two or more solvents are used) in the curable composition is preferably from 20 to 90 mass %, more preferably from 30 to 80 mass %, and particularly preferably from 40 to 80 mass %, with respect to the total mass of the curable composition.

It is preferable that the curable composition further contain at least one polymerization initiator. As the polymerization initiator, a polymerization initiator which generates a radical owing to the action of at least one of heat or light is preferable.

Examples of a polymerization initiator which initiates radical polymerization in response to the action of heat include an organic peroxide, an inorganic peroxide, an organic azo compound, and a diazo compound. Examples of the organic peroxide include benzoyl peroxide, halogenated benzoyl peroxide, lauroyl peroxide, acetyl peroxide, dibutyl peroxide, cumene hydroperoxide, and butyl hydroperoxide. Examples of the inorganic peroxide include hydrogen peroxide, ammonium persulfate, and potassium persulfate. Examples of the organic azo compound include 2-azo-bis-isobutyronitrile, 2-azo-bis-propionitrile, and 2-azo-bis-cyclohexanedinitrile. Examples of the diazo compound include diazoaminobenzene and p-nitrobenzenediazonium.

Examples of a polymerization initiator which initiates radical polymerization in response to the action of light include hydroxyalkylphenones, aminoalkylphenones, acetophenones, benzoins, benzophenones, phosphine oxides, ketals, anthraquinones, thioxanthones, azo compounds, peroxides, 2,3-dialkyldione compounds, disulfide compounds, fluoroamine compounds and aromatic sulfoniums.

Examples of the hydroxyalkylphenones include 2-hydroxy-2-methyl-1-phenyl-1-propan-1-one, 1-hydroxy-cyclohexyl phenyl ketone, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 1-hydroxydimethyl phenyl ketone, and 1-hydroxycyclohexyl phenyl ketone.

Examples of the aminoalkylphenones include 2-dimethylamino-2-(4-methylbenzyl)-1-(4-morpholin-4-yl-phenyl)butan-1-one, 2-benzyl-2-dimethylamino-1-(4-morpholinophenyl)-butanone-1, and 2-methyl-1-(4-methylthiophenyl)-2-morpholinopropan-1-one.

Examples of the acetophenones include 2,2-diethoxyacetophenone, and p-dimethylacetophenone.

Examples of the benzoins include benzoin benzenesulfonic acid ester, benzoin toluenesulfonic acid ester, benzoin methyl ether, benzoin ethyl ether, and benzoin isopropyl ether.

Examples of the benzophenones include benzophenone, 2,4-dichlorobenzophenone, 4,4-dichlorobenzophenone, and p-chlorobenzophenone.

Examples of the phosphine oxides include 2,4,6-trimethylbenzoyl diphenylphosphine oxide.

Further, a sensitizing dye may be used in combination with the above mentioned polymerization initiators.

Although there is no particular restriction on the content of the polymerization initiator, it is preferably from 0.1 to 15 mass %, more preferably from 0.5 to 10 mass %, and particularly preferably from 2 to 5 mass %, with respect to the total solid of the curable composition.

The curable composition may further contain other additional components, if necessary. Examples of additional components include an inorganic oxide particle, a silicone-based or fluorine-based anti-fouling agent, a lubricant, a polymerization inhibitor, a silane coupling agent, a surfactant, a thickener, and a leveling agent.

The content of the additional component(s) is preferably in a range from 0 to 30 mass %, more preferably in a range from 0 to 20 mass %, and particularly preferably in a range from 0 to 10 mass %, with respect to the total solid of the curable resin composition.

Although there is no particular restriction on the thickness of the hydrophobic insulation film, the thickness is preferably from 50 nm to 10 μm, and more preferably from 100 nm to 1 μm. When the thickness of the hydrophobic insulation film is in the above ranges, the balance between the insulation property and the driving voltage is favorable.

Method of Forming Hydrophobic Insulation Film

The hydrophobic insulation film may be formed favorably according to the following method. Namely, the method includes:

forming a curable layer (i.e., curable layer forming step) by applying a curable composition containing a polyfunctional compound onto the surface of a substrate 11 on which electroconductivity has been provided (e.g., in the present embodiment, the surface of the electroconductive film 11a of the substrate 11); and

curing the thus-formed curable layer (i.e., curing step) by polymerizing the polyfunctional compound in the curable layer. By such a method, a hydrophobic insulation film having a cross-linked structure may be formed.

In a case of forming a hydrophobic insulation film 20 as a curable layer on the substrate 11, a known coating method or transfer method may be employed.

In a case of a coating method, a curable layer is formed by coating a curable composition on the substrate 11 (and preferably followed by drying). Examples of the coating method includes known coating methods such as a spin coating method, a slit coating method, a dip coating method, an air-knife coating method, a curtain coating method, a roller coating method, a wire bar coating method, a gravure coating method, or an extrusion coating method.

In a case of a transfer method, a transfer material having a curable layer formed using a curable composition is prepared in advance, and then the curable layer on the transfer material is transferred onto the substrate 11, to thereby form a curable layer on the substrate 11. The details of the transfer method may be disclosed, for example, in Paragraphs 0094 to 0121 of JP-A No. 2008-202006, Paragraphs 0076 to 0090 of JP-A No. 2008-139378, or the like.

Curing of the curable layer (i.e., polymerization of the polyfunctional compound) may be carried out, for example, by applying at least one of irradiation with an active energy ray (hereinafter referred to also as “light exposure” or “exposure”) or heating.

Examples of active energy ray to be used preferably for the exposure include ultraviolet ray (g-line, h-line, i-line, etc.), electron ray, and X ray. The exposure may be performed using a known exposure apparatus of a proximity type, a mirror projection type, a stepper type, or the like. The amount of light for exposure may be from 10 mJ/cm² to 2,000 mJ/cm², and preferably from 50 mJ/cm² to 1,000 mJ/cm².

A hydrophobic insulation film having a desired pattern may be obtained by an exposure through a particular photomask, followed by developing using a developer such as an alkali solution.

The heating may be performed by a known process using, for example, a hot plate or an oven. The heating temperature may be selected appropriately, for example, from 100° C. to 280° C., and preferably is from 150° C. to 250° C. The heating time may be also selected appropriately, for example, from 2 minutes to 120 minutes, and preferably from 5 minutes to 60 minutes.

In the present embodiment, a hydrophilic liquid 14 and an oil 16 are injected between the hydrophobic insulation film 20 and the substrate 12.

The hydrophilic liquid 14 and the oil 16 are liquids which are not miscible to each other, and present separately from each other bounded by an interface 17A or an interface 17B as shown in FIG. 1 and FIG. 2. In FIG. 1 and FIG. 2, the interface 17A indicates an interface between the hydrophilic liquid 14 and the oil 16 in a voltage-off stage, and the interface 17B indicates an interface between the hydrophilic liquid 14 and the oil 16 in a voltage-on stage.

The oil 16 is a non-electroconductive liquid containing at least a nonpolar solvent, a dye, and a nonionic surfactant, wherein the dye content is 10 mass % or more with respect to the total oil composition.

The oil is colored by the dye contained therein. When the content of the dye is 10 mass % or more, or preferably greater than 20 mass %, an image with high contrast ratio, discernibility and clearness is obtained. In case of a formulation containing a dye at such a concentration, the responsiveness of the oil at the time in which a voltage is applied tends to be low, and the image display property tends to deteriorate. However, according to the present invention, by containing a nonionic surfactant, the responsiveness of the oil is improved, and the backflow at the time in which a voltage is applied is suppressed, whereby an electrowetting display apparatus having superior image display properties is obtained.

The term “non-electroconductive” means a property with a specific resistance of 10⁶ Ω·cm or higher, and preferably 10⁷ Ω·cm or higher.

The oil preferably has a relatively low dielectric constant. The dielectric constant of the oil is preferably not more than 10.0, and more preferably in a range from 2.0 to 10.0. It is preferable that the dielectric constant is in the above ranges because, as compared to a case in which the dielectric constant exceeds 10.0, a higher response speed is attained, and driving (operation) at a lower voltage is possible.

The dielectric constant is a value measured by: charging an oil in a glass cell with the cell gap of 10 μm provided with an ITO transparent electrode; and measuring the capacitance of the thus prepared cell using an LCR meter (Model 2353 (trade name), manufactured by NF Corporation; measurement frequency: 1 kHz) at 20° C., 40% RH.

The viscosity of the oil in terms of dynamic viscosity at 20° C. is preferably 10 mPa·s or less. In particular, the viscosity is preferably 0.01 mPa·s or higher, and more preferably from 0.01 mPa·s to 8 mPa·s. It is preferable that the viscosity of the oil is 10 mPa·s or less, because a higher response speed is attained, and driving at a lower voltage is possible, as compared to a case in which the viscosity exceeds 10 mPa·s. Herein, the dynamic viscosity of the oil is the value determined using a viscometer (e.g., Model 500 (trade name), manufactured by Toki Sangyo Co., Ltd.) with the temperature of the oil adjusted to 20° C.

It is preferable that the oil is substantially not miscible with the hydrophilic liquid described below. Specifically, the solubility (25° C.) of the oil in the hydrophilic liquid is preferably 0.1 mass % or less, more preferably 0.01 mass % or less, and particularly preferably 0.001 mass % or less.

Nonpolar Solvent

The oil 16 includes at least one nonpolar solvent. The nonpolar solvent means a solvent having a low dielectric constant (i.e., a so-called nonpolar solvent). Examples of the nonpolar solvent include: an aliphatic hydrocarbon solvent (preferably an aliphatic hydrocarbon solvent having 6 to 30 carbon atoms) such as n-hexane, n-decane, dodecane, tetradecane, or hexadecane; a solvent obtained by substituting the aliphatic hydrocarbon solvent with fluorine, such as a fluorocarbon oil; and a silicone solvent such as a silicone oil. Among these, an aliphatic hydrocarbon solvent is preferable.

The dissolved oxygen concentration in a nonpolar solvent is preferably not more than 10 ppm. When the dissolved oxygen concentration exceeds 10 ppm, deterioration tends to occur, and the responsiveness tends to decrease. It is preferable that the dissolved oxygen concentration is as low as possible, and 8 ppm or less is particularly preferable.

The content of the nonpolar solvent in the oil is preferably 30 mass % or more, and more preferably 40 mass % or more, with respect to the total amount of the oil. When the content of the nonpolar solvent is 30 mass % or more, a superior optical shutter property is attained, and the solubility of a dye contained in the oil is kept well.

The oil may further contain a solvent other than the nonpolar solvent. In this case, the proportion of the nonpolar solvent in the oil is preferably 70 mass % or more, and more preferably 90 mass % or more, with respect to the total amount of the solvents contained in the oil.

Dye

The oil 16 contains at least one dye as a coloring material from a viewpoint of displaying a colored image. As the dye, a dye that is soluble in the nonpolar solvent is preferably selected.

There is no particular restriction on a dye, as long as it is a dye that is soluble in the nonpolar solvent, and a dye selected from known compounds may be used. From a viewpoint of the responsiveness of an oil phase at the time of applying a voltage, a dye having an excellent solubility in a nonpolar solvent, especially in a hydrocarbon solvent, is preferable, or, namely, the solubility of the dye in n-hexane at 25° C., 0.1 MPa is preferably 1 mass % or more. When the solubility is 1 mass % or more, it is suitable for an electrowetting display apparatus. The solubility is preferably 3 mass % or more, and more preferably 5 mass % or more. Although it is preferable that the solubility is as high as possible, it is usually about 80 mass % or less.

The molecular weight of the dye is preferably in a range from 50 to 2,000, more preferably in a range from 100 to 1,500, and particularly preferably in a range from 100 to 1,000.

In the oil, the dyes may be used singly, or a combination of two or more thereof may be used.

The content of the dye in the oil is 10 mass % or more with respect to the total amount of the oil. From a viewpoint of increasing the density and improving clearness of a display image, the content of the dye is preferably higher than 20 mass %, more preferably 40 mass % or more, and further preferably 50 mass % or more, with respect to the total amount of the oil. When the dye content in the oil increases, the responsiveness of the oil at the time in which a voltage is applied decreases and the backflow phenomenon under voltage application also deteriorates, and consequently the image display property tends to deteriorate. Therefore, when the oil formulation has a content of the dye of 10 mass % or more, and preferably higher than 20 mass %, the effects of the present invention are further exerted. Further, from a viewpoint of increasing the response speed, the dye content is preferably 80 mass % or less, more preferably 75 mass % or less, and further preferably 70 mass % or less, with respect to the total amount of the oil.

As the dye, a dye having a structure including a long-chain alkyl group having 6 to 30 carbon atoms is preferable, and especially a dye having a structure including a long-chain alkyl group having 6 to 20 carbon atoms is particularly preferable. By inclusion of a long-chain alkyl group having 6 to 30 carbon atoms in the structure of a dye, the solubility of the oil in the nonpolar solvent is improved, and the responsiveness is improved.

Hereinbelow, description will be given to preferable dyes.

Examples of preferable dyes include an azo dye, an azomethine dye, a methine dye, a phthalocyanine dye, a pyrromethene dye, and an anthraquinone dye.

1. Azo Dye

Examples of an azo dye include an azo dye represented by the following Formula (1).

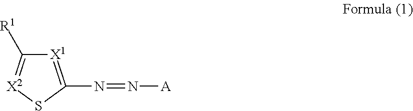

In Formula (1), A represents an aromatic group or a heterocyclic group; R¹ represents a hydrogen atom, an alkyl group, an alkoxy group, a cyano group, a carbonyl group, a halogen atom, an aromatic group, or a heterocyclic group; X¹ and X² each independently represents —C(R²)═ or a nitrogen atom, and R² represents a hydrogen atom, an alkyl group, an alkoxy group, a cyano group, a nitro group, a carbonyl group, an aromatic group, or a heterocyclic group; and R¹ and R² may be bonded together to form a ring structure.

In particular, in order that it is possible to produce an oil formulation having a high dye concentration and having a high solubility in a nonpolar solvent in the oil (i.e., a solubility in n-hexane at 25° C., 0.1 MPa, of 1 mass % or higher), it is preferable that at least one of R¹, X¹, X², or A has an alkyl group having 6 to 30 carbon atoms, and none of R¹, X¹, X², and A has a dissociable group or a halogen atom.

Among the azo dyes represented by Formula (1), the compounds represented by the following Formula (2) or Formula (3) are preferable, because they are superior in solubility in a nonpolar solvent.

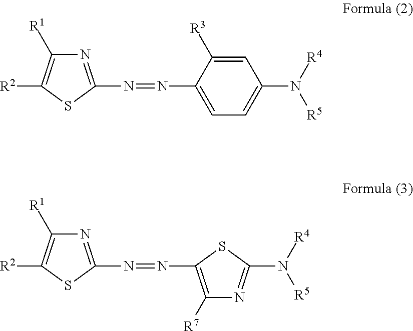

In Formulas (2) and (3), R¹ represents a hydrogen atom, an alkyl group, an alkoxy group, a cyano group, a carbonyl group, an aromatic group, or a heterocyclic group; and R² represents a hydrogen atom, an alkyl group, an alkoxy group, a cyano group, a nitro group, a carbonyl group, an aromatic group, or a heterocyclic group.

In Formula (2), R³ represents a hydrogen atom, an alkyl group, or an alkoxy group. In particular, R³ is preferably a hydrogen atom or an alkyl group having 1 to 20 carbon atoms.

In Formulas (2) and (3), R⁴ and R⁵ each independently represent a hydrogen atom, an alkyl group, or an aromatic group. In particular, it is preferable that at least one of R⁴ or R⁵ represents an alkyl group, and more preferably an alkyl group having 6 to 30 carbon atoms, and further preferably an alkyl group having 6 to 20 carbon atoms. Further, it is more preferable that both of R⁴ and R⁵ represents an alkyl group having 6 to 30 carbon atoms, and preferably an alkyl group having 6 to 20 carbon atoms.

In Formula (3), R⁷ represents a hydrogen atom, an alkyl group, an alkoxy group, a cyano group, a carbonyl group, or an aromatic group. In particular, R⁷ represents preferably a hydrogen atom or an alkyl group having 6 to 20 carbon atoms.

Among the structures represented by Formulas (2) and (3), from a viewpoint of better solubility in the nonpolar solvent, the compounds represented by Formula (2) and (3) are preferable, in which R¹ is an alkyl group or an aryl group, R² is an alkyl group or a cyano group, R³ (in a case of Formula (2); the same applies hereinbelow) is a hydrogen atom or an alkyl group having 6 to 20 carbon atoms, R⁴ and R⁵ are each independently a hydrogen atom or an alkyl group, and R⁷ (in a case of Formula (3); the same applies hereinbelow) is a hydrogen atom or an alkyl group having 6 to 20 carbon atoms. Furthermore, in the structures of the formulas (2) and (3), it is more preferable that R¹ is and alkyl group having 6 to 20 carbon atoms, R² is a cyano group, R³ is a hydrogen atom or an alkyl group having 6 to 20 carbon atoms, R⁴ and R⁵ are each independently an alkyl group having 6 to 30 carbon atoms, or more preferably having 6 to 20 carbon atoms, and R⁷ is a hydrogen atom or an alkyl group having 6 to 20 carbon atoms.

Further, an azo dye may be a compound having an optically active carbon atom, in order that it is possible to additionally increase the solubility of the dye in the nonpolar solvent and to decrease the viscosity. In particular, the presence of plural optically active moieties (i.e., optically active sites) in a molecule is preferable, and the presence of 3 or more optically active moieties (i.e., optically active sites) in a molecule is further effective for enhancing the solubility in the nonpolar solvent. Examples of a substituent having an optically active site for a dye include a branched alkyl group having 6 to 30 carbon atoms and having optically active site(s), and an alicyclic alkyl group having 6 to 30 carbon atoms and having optically active site(s).

The presence of an optically active site in a molecule may be found by analyzing the chemical structure of the molecule to examine whether all of the 4 substituents of one carbon atom are different groups. Whether or not a certain dye compound having an optically active site is a mixture of stereoisomers may be determined easily by preparing a solution of the same and measuring the optical rotation of the solution to confirm that the solution does not show optical rotation (namely, the optical rotation is 0°).

Specific examples of the azo dye are shown below, provided that the present invention is not limited to the specific examples. In the followings, “Me” indicates a methyl group, “Et” indicates an ethyl group, “Bu” indicates a butyl group, and “Ph” indicates a phenyl group, respectively.

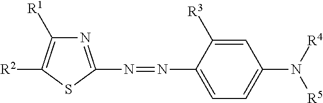

| | | | | | | Optically |
|---|---|---|---|---|---|---|
| Number | R¹ | R² | R³ | R⁴ | R⁵ | active site |
| D-1 | t-Bu | CN | H | n-C₈H₁₇ | n-C₈H₁₇ | 0 |
| D-2 | Me | CN | Me | n-C₈H₁₇ | n-C₈H₁₇ | 0 |
| D-3 | CH₂CHEtC₄H₉ | CN | MeO | CH₂CHEtC₄H₉ | CH₂CHEtC₄H₉ | 2 |
| D-4 | Ph | NO₂ | Et | n-C₁₀H₂₁ | n-C₁₀H₂₁ | 0 |
| D-5 | n-C₈H₁₇ | Me | Me | Et | Et | 0 |

| | |
|---|---|
| D-6 | 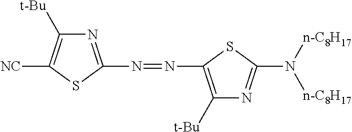 (Optically active site: 0) |
| D-7 | 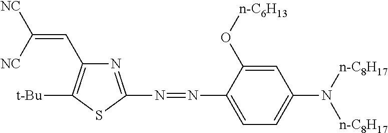 (Optically active site: 0) |

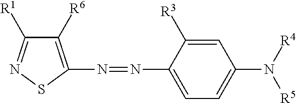

| | | | | | | Optically |
|---|---|---|---|---|---|---|
| Number | R¹ | R⁶ | R³ | R⁴ | R⁵ | active site |
| D-8 | Me | CN | H | n-C₈H₁₇ | n-C₈H₁₇ | 0 |
| D-9 | t-Bu | CN | Me | n-C₈H₁₇ | n-C₈H₁₇ | 0 |
| D-10 | i-Pr | CO₂CH₂CHEtC₄H₉ | MeO | CH₂CHEtC₄H₉ | CH₂CHEtC₄H₉ | 2 |
| D-11 | n-C₈H₁₇ | NO₂ | H | Et | Et | 0 |

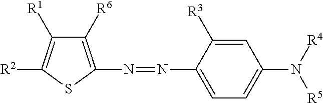

| | | | | | | | Optically |
|---|---|---|---|---|---|---|---|
| Number | R² | R¹ | R⁶ | R³ | R⁴ | R⁵ | active site |
| D-12 | CO₂C₆H₁₃ | Me | CO₂C₆H₁₃ | NHCOC₆H₁₃ | n-C₈H₁₇ | n-C₈H₁₇ | 0 |
| D-13 | Me | Me | CN | Me | n-C₈H₁₇ | n-C₈H₁₇ | 0 |
| D-14 | Bu | CH₂CO₂Et | CO₂Et | MeO | n-C₁₀H₂₁ | n-C₁₀H₂₁ | 0 |
| D-15 | n-C₈H₁₇ | Me | CO₂Et | C₆H₁₃O | Et | Et | 0 |

| | |
|---|---|
| D-16 | 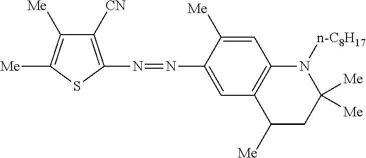 (Optically active site: 1) |
| D-17 | 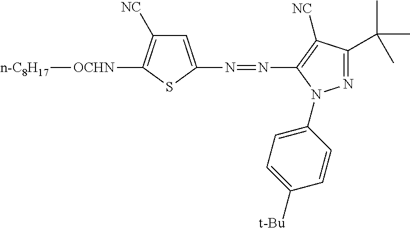 |
| D-18 | 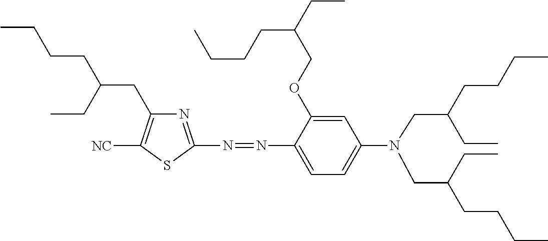 [SMILES: CCCCC(CC)COc1cc(N(CC(CC)CCCC)CC(CC)CCCC)ccc1N=Nc1nc(CC(CC)CCCC)c(C#N)s1] (Optically active site: 3) |
| D-19 | 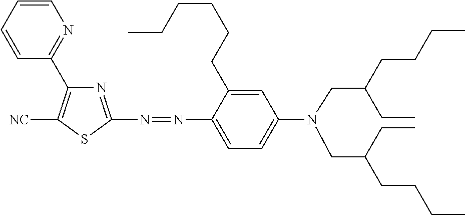 [SMILES: CCCCCCc1cc(N(CC(CC)CCCC)CC(CC)CCCC)ccc1N=Nc1nc(-c2ccccn2)c(C#N)s1] (Optically active site: 1) |
| D-20 | 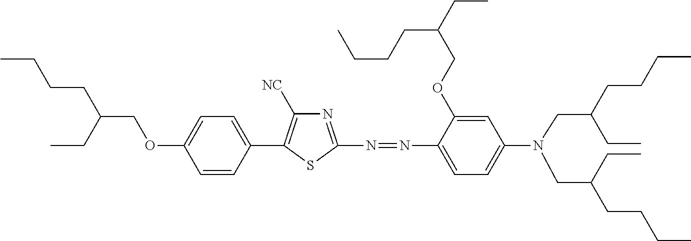 [SMILES: CCCCC(CC)COc1ccc(-c2sc(N=Nc3ccc(N(CC(CC)CCCC)CC(CC)CCCC)cc3OCC(CC)CCCC)nc2C#N)cc1] (Optically active site: 3) |
| D-21 | 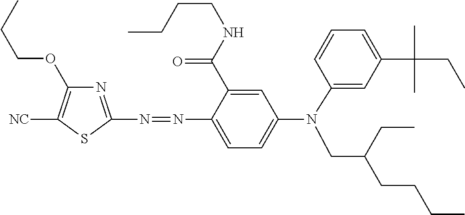 [SMILES: CCCCNC(=O)c1cc(N(CC(CC)CCCC)c2cccc(C(C)(C)CC)c2)ccc1N=Nc1nc(OCCC)c(C#N)s1] (Optically active site: 1) |
| D-22 | 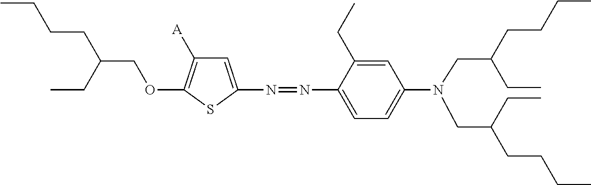 (Optically active site: 2) |
| D-23 | 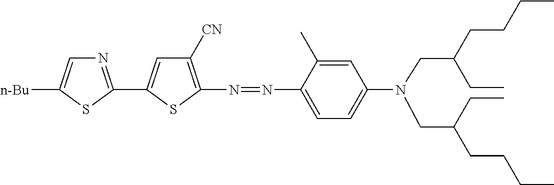 (Optically active site: 1) |
| D-24 | 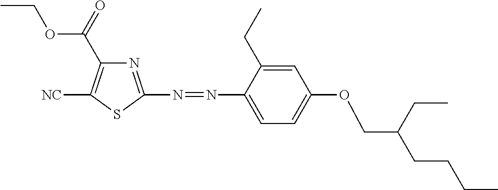 [SMILES: CCCCC(CC)COc1ccc(N=Nc2nc(C(=O)OCC)c(C#N)s2)c(CC)c1] (Optically active site: 1) |

Other examples of preferable azo dyes include those represented by the following Formula (2).

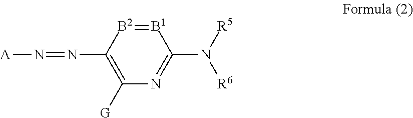

In Formula (2), A represents a residue of a 5-membered heterocyclic diazo component A-NH₂; B¹ and B² each independently represent —CR¹═, —CR²═, or a nitrogen atom, and both of B¹ and B² do not represent nitrogen atoms; R⁵ and R⁶ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group; G, R¹, and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxyl group, an alkoxy group, an aryloxy group, a silyloxy group, an acyloxy group, a carbamoyloxy group, a heterocyclic oxy group, an alkoxycarbonyloxy group, an aryloxycarbonyloxy group, a substituted amino group substituted by an alkyl group, a substituted amino group substituted by an aryl group, a substituted amino group substituted by a heterocyclic group, an acylamino group, a ureido group, a sulfamoylamino group, an alkoxycarbonylamino group, an aryloxycarbonylamino group, an alkylsulfonylamino group, an arylsulfonylamino group, an aryloxycarbonylamino group, a nitro group, an alkylthio group, an arylthio group, an alkylsulfonyl group, an arylsulfonyl group, an alkylsulfinyl group, an arylsulfinyl group, a sulfamoyl group, a sulfo group, or a heterocyclic thio group. R¹ and R⁵ may be bonded to each other to form a 5-membered or 6-membered ring. R⁵ and R⁶ may be bonded to each other to form a 5-membered or 6-membered ring.

With respect to the azo dyes represented by Formula (2), a reference may be made to the description in Paragraphs 0033 to 0071 of JP-A No. 2006-126649.

Synthesis of an azo dye may be performed by the methods described in “Shin Senryou Kagaku (New Dye Chemistry)”, written by Hosoda Yutaka, Gihodo Shuppan Co., Ltd., 21. 12. 1973; “Dichroic Dyes for Liquid Crystal Displays”, written by A. V. Ivashchenko, CRC Press, 1994; Bulletin of the Chemical Society of Japan, vol. 76, p. 607-612, 2003; and Bulletin of the Chemical Society of Japan, vol. 72, p. 127-132, 1999.

2. Azomethine Dye

Examples of a preferable azomethine dye include those represented by the following Formula (3).

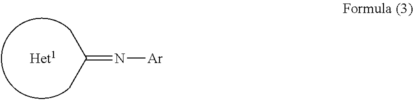

In Formula (3), Het¹ represents a ring having no dissociable group, and Ar represents an aromatic ring or saturated heterocyclic ring which has no dissociable group. In particular, the azomethine dye preferably has at least one straight-chain or branched alkyl group (preferably a straight-chain alkyl group) having a relatively large number of carbon atoms, namely 6 to 30 carbon atoms, in a dye molecule, from a viewpoint that it is possible to obtain an oil formulation having a high dye concentration and having a high solubility in the nonpolar solvent of the oil (a solubility in n-hexane at 25° C., 0.1 MPa or 1 mass % or more).

Specific examples of azomethine dyes are shown below, provided that the present invention is not limited to the specific examples. In the followings, “Me” indicates a methyl group, “Et” indicates an ethyl group, “Pr” indicates a propyl group, “Bu” indicates a butyl group, and “Ph” indicates a phenyl group, respectively.

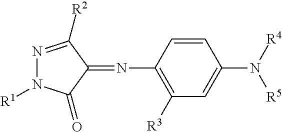

| Number | R¹ | R² | R³ | R⁴ | R⁵ |
|---|---|---|---|---|---|
| E-1 | Ph | Me | Me | n-C₈H₁₇ | n-C₈H₁₇ |
| E-2 | i-Pr | t-Bu | Me | n-C₈H₁₇ | n-C₈H₁₇ |
| E-3 | C₆H₁₃ | EtO | MeO | CH₂CHEtC₄H₉ | CH₂CHEtC₄H₉ |
| E-4 | Ph | i-Pr | Et | n-C₁₀H₂₁ | n-C₁₀H₂₁ |
| E-5 | n-C₈H₁₇ | t-Bu | Me | Et | Et |

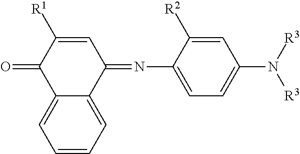

| Number | R¹ | R² | R³ |
|---|---|---|---|
| E-6 | H | H | n-C₈H₁₇ |
| E-7 | Et | H | CH₂CHEtC₄H₉ |
| E-8 | CONHC₁₆H₃₃ | Et | Et |
| E-9 | CONHC₁₆H₃₃ | H | n-Bu |

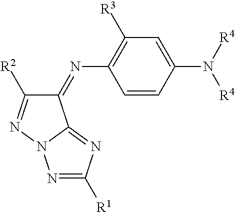

| Number | R¹ | R² | R³ | R⁴ |
|---|---|---|---|---|
| E-10 | i-Pr | t-Bu | H | n-C₈H₁₇ |
| E-11 | t-Bu | i-Pr | Me | CH₂CHEtC₄H₉ |

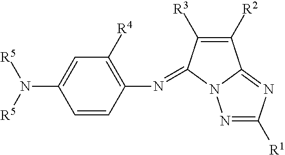

| Number | R¹ | R² | R³ | R⁴ | R⁵ |
|---|---|---|---|---|---|
| E-12 | 4-t-Bu—Ph | EST1 | CN | Me | n-C₈H₁₇ |
| E-13 | t-Bu | t-Bu | Me | H | CH₂CHEtC₄H₉ |
| E-14 | n-C₈H₁₇ | Me | CN | Et | n-C₈H₁₇ |
| E-15 | t-Bu | EST1 | MeO | H | n-C₁₀H₂₁ |

The structure of “EST1” mentioned above is as follows. In the structure shown below, the wavy line indicates the binding site.

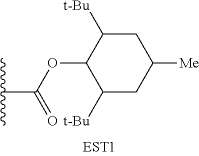 [SMILES: *C(=O)OC1C(C(C)(C)C)CC(C)CC1C(C)(C)C]

Synthesis of the azomethine dye used in the present invention may be performed according to the methods described in J. Am. Chem. Soc., 1957, vol. 79, p. 583; JP-A No. 9-100417; JP-A No. 2011-116898; JP-A No. 2011-12231; JP-A No. 2010-260941; or JP-A No. 2007-262165.

3. Methine Dye

Examples of a preferable methine dye include those represented by the following Formula (4).

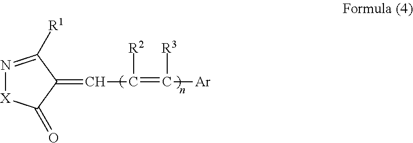

In Formula (4), R¹ represents a hydrogen atom, an alkyl group, an aryl group, —COOR¹¹, or —CONR¹¹R¹²; Ar represents an aromatic ring; R² and R³ each independently represent a hydrogen atom, or an alkyl group; R¹¹ and R¹² each independently represent a hydrogen atom, an alkyl group, or an aryl group. R¹¹ and R¹² may be bonded to each other to form a 5-membered ring, 6-membered ring, or a 7-membered ring. Furthermore, n represents an integer from 0 to 2. R¹, R², R³, and Ar do not have a dissociable group. X is an oxygen atom or N—R¹³, and R¹³ represents a hydrogen atom, an alkyl group, or an aryl group.

Specific examples of azomethine dyes are shown below, provided that the present invention is not limited thereto. In the followings, “Me” indicates a methyl group, “Et” indicates an ethyl group, “Pr” indicates a propyl group, “Bu” indicates a butyl group, and “Ph” indicates a phenyl group, respectively.

| | |
|---|---|
| F-1 | 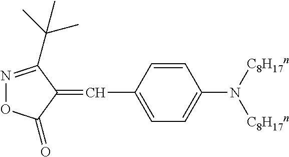 |
| F-2 | 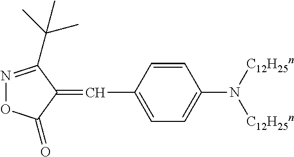 |
| F-3 | 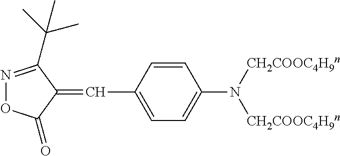 |
| F-4 | 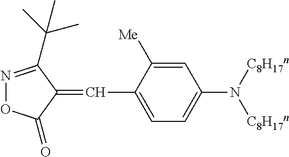 |

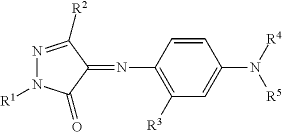

| Number | R¹ | R² | R³ | R⁴ | R⁵ |
|---|---|---|---|---|---|
| F-5 | Me | Me | H | n-C₈H₁₇ | n-C₈H₁₇ |
| F-6 | i-Pr | t-Bu | Me | n-C₈H₁₇ | n-C₈H₁₇ |
| F-7 | C₆H₁₃ | EtO | MeO | n-C₈H₁₇ | n-C₈H₁₇ |
| F-8 | Ph | i-Pr | Et | n-C₁₀H₂₁ | n-C₁₀H₂₁ |
| F-9 | n-C₈H₁₇ | Me | ET1 | Et | Et |

The structure of “ET1” mentioned above is as follows. In the structure shown below, the wavy line indicates the binding site.

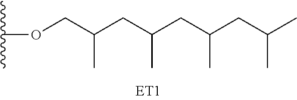 [SMILES: *OCC(C)CC(C)CC(C)CC(C)C]

These compounds may be produced by a known method described, for example, in Japanese Patent No. 2707371 as well as JP-A No. 5-45789, JP-A No. 2009-263517, JP-A No. 3-72340, or the like.

4. Phthalocyanine Dye

As a phthalocyanine dye, a phthalocyanine dye having an alkyl group having 6 or more carbon atoms is preferable.

Specific examples thereof include the colorants described, for example, in Applied Physics Express, vol. 4, p. 21604, 2011; Molecular Crystal Liquid Crystal, vol. 183, p. 411, 1990; or Molecular Crystal Liquid Crystal, vol. 260, p. 255, 1995; and colorants represented by the formula (C1) described in JP-A No. 2006-133508.

5. Anthraquinone Dye

Examples of a preferable anthraquinone dye include those represented by the following Formula (5).

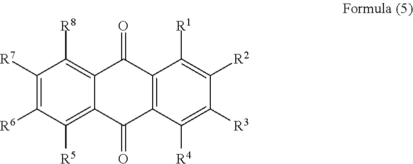

In Formula (5), R¹, R⁴, R⁵ and R⁸ each independently represent a hydrogen atom, NR¹¹R¹², an alkylthio group, an arylthio group, an alkoxy group, or an aryloxy group; R², R³, R⁶, and R⁷ each independently represent a hydrogen atom, an alkyl group, or an alkoxycarbonyl group. R¹¹ and R¹² each independently represent a hydrogen atom, an alkyl group, an aryl group, or a heterocyclic group, provided that both of R¹¹ and R¹² do not represent hydrogen atoms. With respect to Formula (5), an embodiment having and alkyl group having 4 or more carbon atoms is preferable. Specific examples thereof include those described in WO 2008/142086.

Synthesis of the anthraquinone dye may be performed by the methods described in “Shin Senryou Kagaku (New Dye Chemistry)”, written by Hosoda Yutaka, Gihodo Shuppan Co., Ltd., 21. 12. 1973; and “Dichroic Dyes for Liquid Crystal Displays”, written by A. V. Ivashchenko, CRC Press, 1994.

Nonionic Surfactant

The oil 16 includes at least one nonionic surfactant. As described above, the oil used in the present invention has a formulation containing a dye at a proportion of 10 mass % or higher, and by further containing a nonionic surfactant, the responsiveness of the oil is improved, while realizing a high concentration of the dye. Further, the backflow phenomenon when kept under voltage application is eliminated, and a good image display properties are exhibited.

Although there is no particular restriction on the nonionic surfactant, compounds represented by the following Formula (6) are preferable.

A-B Formula (6)

In Formula (6), A represents a hydrophobic moiety, and B represents a hydrophilic moiety. The “A” is preferably formed from a group selected from the group consisting of an alkyl group and an aryl group, and the “B” is preferably formed from a group selected from the group consisting of an ester group, an alkylene ether group, and a hydroxyl group. The “A” may contain two or more alkyl groups and/or two or more aryl groups. In such a case, the alkyl groups and aryl groups may be the same or different from one another, respectively. The “B” may contain two or more ester groups, two or more alkylene ether groups, and/or two or more hydroxyl groups, and in such a case, the ester groups and alkylene ether groups may be the same or different from one another, respectively.

The alkyl group included in the A may be unsubstituted, or substituted by a fluorine atom. From a viewpoint of hydrophobicity to be imparted, the alkyl group contains preferably a relatively large number of carbon atoms. Specifically, the alkyl group is preferably a straight-chained or branched alkyl group having 6 to 30 carbon atoms. Example of alkyl group include a hexyl group, a heptyl group, an octyl group, a nonyl group, a decyl group, a dodecyl group, and a cetyl group.

The aryl group included in the A may be unsubstituted or substituted, and is preferably an aryl group having 6 to 30 carbon atoms. Example of aryl group include a phenyl group and a naphthalene group.

The ester group included in the B is preferably an alkyl ester represented by RCOO—, wherein R is an alkyl group having 5 to 30 carbon atoms. The alkyl group represented by R is preferably an alkyl group having 8 to 20 carbon atoms.

Favorable examples of alkylene ether group included in the B include an ethyleneoxy group (CH₂CH₂O), and a propyleneoxy group (CH₂CH₂CH₂O). As the alkylene ether group, an ethyleneoxy chain represented by (CH₂CH₂O)ₙ, wherein n=4 to 20, is preferable, and n in a range from 5 to 10 is more preferable, from a viewpoint of the responsiveness (display property) and prohibition of the backflow of the oil at an elevated dye concentration.

The molecular weight of the nonionic surfactant is preferably in a range from 50 to 3,000, and more preferably in a range from 100 to 2,000. When the molecular weight is in the above ranges, it is advantageous in terms of the responsiveness and the response speed.

Examples of compounds represented by Formula (6) include the following compounds.

### (1) Glycerin Fatty Acid Esters

Those represented by RCOOCH₂CH(OH)CH₂OH are exemplified, wherein R is preferably an aliphatic group (preferably an alkyl group) having 5 to 30 carbon atoms, and more preferably an aliphatic group (preferably an alkyl group) having 8 to 20 carbon atoms.

Specific examples of glycerin fatty acid esters include C₆H₁₃COOCH₂CH(OH)CH₂OH, C₈H₁₇COOCH₂CH(OH)CH₂OH, C₁₀H₂₁COOCH₂CH(OH)CH₂OH, C₁₁H₂₃COOCH₂CH(OH)CH₂OH, C₁₂H₂₅COOCH₂CH(OH)CH₂OH, and C₁₃H₂₇COOCH₂CH(OH)CH₂OH.

Further, as the glycerin fatty acid ester, a commercial product on the market may be used, and examples of trade names include HOMOTEX (manufactured by Kao Corporation), EXCEL (manufactured by Kao Corporation), SUNSOFT (manufactured by Taiyo Kagaku Co., Ltd.), and RIKEMAL (manufactured Riken Vitamin Co., Ltd.).

### (2) Fatty Alcohol Ethoxylates

Those represented by RO(CH₂CH₂O)ₙH are exemplified, wherein R is preferably an aliphatic group (preferably an alkyl group) having 5 to 30 carbon atoms, and more preferably an aliphatic group (preferably an alkyl group) having 8 to 20 carbon atoms; and n is preferably from 3 to 50, and more preferably from 5 to 10.

Specific examples of fatty alcohol ethoxylates include C₈H₁₇O(CH₂CH₂O)₂H, C₈H₁₇O(CH₂CH₂O)₃H, C₁₀H₂₁O(CH₂CH₂O)₃H, C₁₀H₂₁O(CH₂CH₂O)₄H, C₁₁H₂₃O(CH₂CH₂O)₃H, C₁₂H₂₅O(CH₂CH₂O)₄H, C₁₅H₃₁O(CH₂CH₂O)₂H, C₁₆H₃₃O(CH₂CH₂O)₄H, and C₂₀H₄₁O(CH₂CH₂O)₄H.

Further, as the fatty alcohol ethoxylates, a commercial product on the market may be used, and examples of trade names include PIONIN (manufactured by Takemoto Oil & Fat Co., Ltd.), BLAUNON (manufactured by Aoki Oil Industrial Co., Ltd.), EMULGEN (manufactured by Kao Corporation), ADEKA TOL (manufactured by Adeka Corporation), and NOIGEN (manufactured by Dai-Ichi Kogyo Seiyaku Co., Ltd.).

### (3) Polyoxyethylene Alkyl Phenyl Ethers

Those represented by RC₆H₄—O—(CH₂CH₂O)ₙH are exemplified, wherein R is preferably an aliphatic group (preferably an alkyl group) having 5 to 30 carbon atoms, and more preferably an aliphatic group (preferably an alkyl group) having 8 to 20 carbon atoms; and n is preferably from 3 to 50, and more preferably from 5 to 10.

Specific examples of polyoxyethylene alkyl phenyl ethers include C₆H₁₃C₆H₄—O—(CH₂CH₂O)₃H, and C₉H₁₉C₆H₄—O—(CH₂CH₂O)₂H.

### (4) Alkyl Glycosides

Those represented by RC₆H₁₁O₆ are exemplified, wherein R is preferably an alkyl group having 5 to 30 carbon atoms, and more preferably an alkyl group having 8 to 20 carbon atoms. Specific examples of alkyl glycosides are shown below.

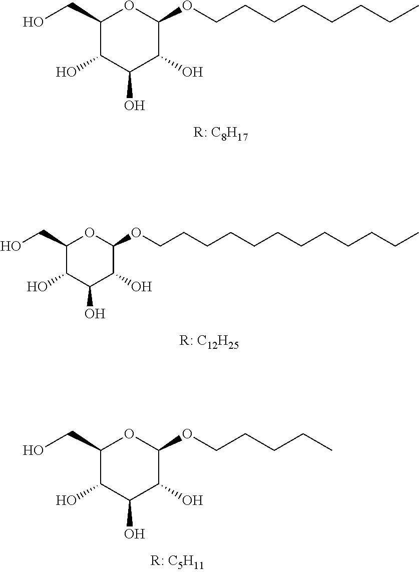 [SMILES: CCCCCCCCO[C@@H]1O[C@H](CO)[C@@H](O)[C@H](O)[C@H]1O ; CCCCCCCCCCCCO[C@@H]1O[C@H](CO)[C@@H](O)[C@H](O)[C@H]1O ; CCCCCO[C@@H]1O[C@H](CO)[C@@H](O)[C@H](O)[C@H]1O]

### (5) Fluorinated Alkyl-Alkyl Surfactants

F(CF₂)ₙSO₂NR(CH₂)ₘH, F(CF₂)ₙCO₂(CH₂)ₘH, and F(CF₂)ₙOCO(CH₂)ₘH are exemplified.

In the above formulas, n represents 3 to 50, and preferably 5 to 10; m represents 3 to 50, and preferably 5 to 10; and R represents a hydrogen atom, or an alkyl group preferably having 6 to 20 carbon atoms.

Specific examples of fluorinated alkyl-alkyl surfactants include F(CF₂)₆SO₂N(CH₃)(CH₂)₆H, F(CF₂)₆CO₂(CH₂)₁₀H, F(CF₂)₈CO₂(CH₂)₈H, F(CF₂)₉CO₂(CH₂)₆H, and F(CF₂)₆OCO(CH₂)₁₃H.

### (6) Sorbitan Esters

Examples of sorbitan esters include compounds represented by RCOOCH₂C₅H₉O₄. In the formula, R is preferably an alkyl group having 5 to 30 carbon atoms, and more preferably an alkyl group having 8 to 20 carbon atoms. Specific examples of sorbitan esters are shown below, provided that the present invention is not limited thereto.

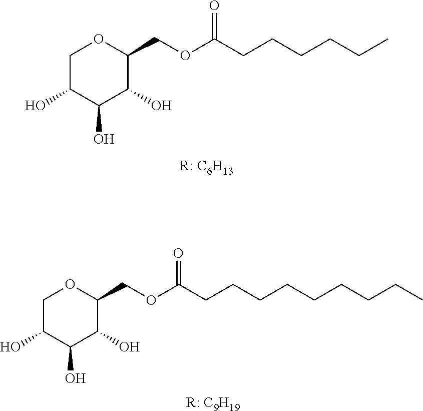 [SMILES: CCCCCCC(=O)OC[C@@H]1OC[C@@H](O)[C@H](O)[C@H]1O ; CCCCCCCCCC(=O)OC[C@@H]1OC[C@@H](O)[C@H](O)[C@H]1O ; "R: C9H19"]

Among the above mentioned compounds, a compound having an ethyleneoxy chain [(CH₂CH₂O)ₙ] or a propyleneoxy chain in a molecule is preferable from the viewpoints of the responsiveness of the oil and prohibition of the backflow under voltage application. Furthermore, a compound having an ethyleneoxy chain is more preferable, a compound having (CH₂CH₂O)ₙ, in which n is an integer from 4 to 20, is more preferable, and n is further preferably in a range from 5 to 10.

The content of the nonionic surfactant in the oil is preferably from 0.001 to 10 mass %, and more preferably from 0.05 to 1 mass %, with respect to the dye content. When the content of nonionic surfactant is within the above ranges, the responsiveness to an applied voltage is further improved when a formulation is made to have a dye in a range of 10 mass % or higher.

As the nonionic surfactant, a nonionic surfactant which is capable of reducing the interfacial tension of the oil when being added therein, is preferable. Such a nonionic surfactant is preferably a surfactant that is capable of reducing the interfacial tension of the oil by 5% or more, and more preferably by 10% or more, as compared to the interfacial tension of the oil without containing the nonionic surfactant.

Various Additives

The oil may further contain, as other components, various additives such as an ultraviolet absorber or an anti-oxidant, according to need. When an additive is added, there is no particular restriction on the content thereof, but usually the content is about 20 mass % or less with respect to the total mass of the oil.

The oil may be prepared as a black color ink or the like using a single dye, or may be prepared as a black color ink using a mixture of plural dyes.

When plural dyes are combined, a combination of a yellow dye having an absorption wavelength range from 400 to 500 nm, a magenta dye having absorption wavelength range from 500 to 600 nm, and a cyan dye having an absorption wavelength range from 600 to 700 nm is preferably used.

Herein, the “black color” means a characteristic in that the differences between the maximum transmittances and the minimum transmittances at 450 nm, 500 nm, 550 nm, and 600 nm are 20% or less, respectively, and the differences are preferably 15% or less, and particularly preferably 10% or less.

The hydrophilic liquid 14 is an electroconductive hydrophilic liquid. Herein, the term “electroconductive” means a characteristic in that the specific resistance is 10⁵ Ω·cm or less, and preferably 10⁴ Ω·cm or less.

The hydrophilic liquid is formed by containing, for example, an electrolyte and an aqueous solvent.

Examples of the electrolyte include salts such as sodium chloride, potassium chloride, or tetrabutylammonium chloride. The concentration of electrolyte in the hydrophilic liquid is preferably from 0.1 to 10 mol/L, and more preferably from 0.1 to 5 mol/L.

As the aqueous solvent, water and an alcohol are suitable, and an aqueous solvent other than water may be contained. Examples of alcohol include ethanol, ethylene glycol, and glycerol.

It is preferable that the aqueous solvent does not contain the nonionic surfactant used in the present invention, from a viewpoint of the responsiveness.

In an electrowetting display apparatus 100, a power source 25 (voltage applying means) that applies a voltage between the electroconductive film 11b and the electroconductive film 12b through the hydrophilic liquid 14, and a switch 26 that enables turning on/off of the voltage are electrically connected.

In the present embodiment, a voltage (electric potential) is applied to the hydrophilic liquid 14 by applying the voltage to the electroconductive film 12b provided on the substrate 12. In this manner, the present embodiment has a configuration in which the surface of the substrate 12 that is being brought into contact with the hydrophilic liquid 14 has an electroconductive structure (a configuration in which an ITO film as an electroconductive film is present on the surface of the substrate material 12a which is in contact with the hydrophilic liquid 14), provided that the present invention is not limited to such an embodiment. For example, an electroconductive film 12b may not be provided on the substrate 12, and an electrode may be inserted in the hydrophilic liquid 14 so that it is possible to apply a voltage (electric potential) from the inserted electrode to the hydrophilic liquid 14.

Next, the operation (voltage on state and voltage off state) of the electrowetting display apparatus 100 will be described.

As shown in FIG. 1, in the voltage off state, the affinity of the oil 16 with the hydrophobic insulation film 20 is relatively high, whereby the oil 16 is brought into contact with the entire surface of the hydrophobic insulation film 20. When the switch 26 of the electrowetting display apparatus 100 is turned on and a voltage is applied, the interface between the hydrophilic liquid 14 and the oil 16 changes its form from the interface 17A shown in FIG. 1 to the interface 17B shown in FIG. 2. As a result, the contact area of the hydrophobic insulation film 20 with the oil 16 decreases, and the oil 16 moves to an end of the cell as shown in FIG. 2. This phenomenon occurs because the surface of the hydrophobic insulation film 20 is electrically charged by the voltage application, and, due to the charge, the hydrophilic liquid 14 pushes the oil 16, which has been brought into contact with the hydrophobic insulation film 20, away, and comes to contact the hydrophobic insulation film 20.

When the switch 26 of the electrowetting display apparatus 100 is turned off to the voltage off state, the state in FIG. 1 is recovered.

In the electrowetting display apparatus 100, the operations of changing the states between the states shown in FIG. 1 and FIG. 2 are repeatedly performed.

Although an embodiment of an electrowetting display apparatus is described above by referring to FIG. 1 and FIG. 2, the present invention is not limited to the embodiment.

For example, although the electroconductive film 11b is provided over the entire surface of the substrate material 11a of the substrate 11 in FIG. 1 and FIG. 2, the electroconductive film 11b may be provided only on a part of the surface of the substrate material 11a. Meanwhile, although the electroconductive film 12b is provided over the entire surface of the substrate material 12a of the substrate 12 in FIG. 1 and FIG. 2, the electroconductive film 12b may be provided only on a part of the surface of the substrate material 12a.

In embodiments, a dye may be added to the oil 16 so as to color the oil 16 with a desired color (for example, black, red, green, blue, cyan, magenta, or yellow), whereby it is possible to attain the function as a pixel for an image display of an electrowetting display apparatus. In this case, the oil 16 functions, for example, as an optical shutter that is capable of switching the on-state and the off-state of the pixel. In this case, the electrowetting display apparatus may be constituted as any of a transmissive system, a reflective system, or a semi-transmissive system.

Further, in the electrowetting display apparatus of the present embodiment, at least one outer surface (opposite to the surface facing the oil) of the first substrate or the second substrate may be provided with a UV shielding layer. As a result, the light resistance of the display apparatus is improved.

As the UV shielding layer, a known UV shielding layer may be used, and, for example, a UV shielding layer (for example, UV shielding film) containing an ultraviolet absorber may be used. It is preferable that the UV shielding layer absorbs 90% or more of light at a wavelength of 380 nm.

The UV shielding layer may be attached to at least one outer surface of the first substrate or the second substrate by a known method such as adhesion using an adhesive.

In an electrowetting display apparatus, the structure shown in FIG. 1 (a region (display cell) which is formed by partitioning the space between the hydrophobic insulation film 20 and the substrate 12 with the silicone rubber wall 22a and the silicone rubber wall 22b, in a lattice form or the like; for example, in a grid pattern) is used as a pixel that is a component of a display unit. By arranging plural of the display cells in two dimensions, it is possible to obtain an image display. In this case, the electroconductive film 11b may be a film which has been patterned independently for each pixel (display cell) (for example, in the case of an active matrix type image display apparatus), or a film which has been patterned in a stripe form spanning over plural pixels (display cells) (for example, in the case of a passive matrix type image display apparatus).

In the electrowetting display apparatus 100, a substrate having optical transparency, such as glass or plastic (polyethylene terephthalate, polyethylene naphthalate, etc.) is used for the substrate material 11a and the substrate material 12a, a film having optical transparency is used for the electroconductive films 11b, 12b and the hydrophobic insulation film 20, whereby the electrowetting display apparatus 100 is used as a transmissive display apparatus. In the pixels of the transmissive display apparatus, by placing a reflective plate outside the display cell, a reflective display apparatus may be constituted.

Meanwhile, pixels of a reflective image display apparatus may be formed by, for example, using a film having a function of a reflective plate (for example, a metal film such as an Al film or an Al-alloy film) for the electroconductive film 11b, or using a substrate having a function of a reflective plate (for example, a metal substrate such as an Al substrate or an Al-alloy substrate) for the substrate material 11a.

A display cell that is a constituent component of the electrowetting display apparatus 100 of the present embodiment, or other configuration of the image display apparatus may follow known configurations as described, for example, in JP-A No. 2009-86668, JP-A No. 10-39800, Japanese National Publication of International Patent Application No. 2005-517993, JP-A No. 2004-252444, JP-A No. 2004-287008, Japanese National Publication of International Patent Application No. 2005-506778, Japanese National Publication of International Patent Application No. 2007-531917, and JP-A No. 2009-86668. Furthermore, a reference may be made to a known configuration of an active matrix type or passive matrix type liquid crystal display apparatus.

An electrowetting display apparatus may be formed using, according to need, in addition to the display cells (display pixels), other constituent components similar as those used in known liquid crystal display apparatuses, such as a backlight, a cell gap adjusting spacer, or a sealing material for sealing. In this case, the oil and hydrophilic liquid may be placed, for example, by an ink jet process in a region partitioned by silicone rubber walls on the substrate 11.

The electrowetting display apparatus 100 of the present embodiment may be produced, for example, by a method including: preparing a substrate 11 (substrate preparation step); forming a hydrophobic insulation film 20 on an electroconductive surface of the substrate 11; forming partition walls that partition the surface of the formed hydrophobic insulation film 20 on the substrate 11 (partition wall forming step); applying an oil 16 and a hydrophilic liquid 14 (for example, by an ink-jet process) to the region partitioned by the partition walls (application step); forming a cell (display unit) by superimposing the substrate 12 onto the surface of the substrate 11 on which the oil 16 and hydrophilic liquid 14 have been applied (cell forming step); and, if necessary, sealing the cell by bonding the substrate 11 and the substrate 12 around the cells (sealing step). The bonding of the substrate 11 and the substrate 12 may be performed using a sealing material commonly used for manufacturing a liquid crystal display apparatus.

Further, after the partition wall forming step and before the cell forming step, a spacer forming step for forming a cell gap adjusting spacer may be provided.

### EXAMPLES

The present invention will be described below more specifically by means of Examples, provided that the present invention be not limited thereto unless departing from the spirit and scope of the invention. Unless otherwise specified, “part(s)” means “part(s) by mass”.

### Example 1

### Preparation of Dye Ink

Using the surfactants listed below, argon gas to which the surfactants were added at a rate of 1 mass % as shown in the following Table 1, respectively, was bubbled into n-decane, to thereby prepare an n-decane solution having a dissolved oxygen concentration of 10 ppm or less. The prepared n-decane solution was subjected to a heat-treatment at 50° C. and left standing at room temperature for 12 hours. After that, to the thus-treated n-decane solution, the dye E-11 mentioned below was added in an amount specified in the following Table 1 and Table 2 (40 mass % or 10 mass %). In this manner, plural kinds of dye inks were prepared.

All of the prepared oils were red.

Details of surfactants are as follows.

Compound K-1: n-C₁₆H₃₃O(CH₂CH₂O)₈H

Compound K-2: n-C₁₂H₂₅O(CH₂CH₂O)₄H

Compound K-3: n-C₇F₁₅CO₂C₂₂H₄₅

Compound K-4: Tween 20 (polyoxyethylene sorbitan monolaurate)

Compound K-5: n-C₉F₁₉SO₂N(n-Pr)CH₂CH₂(CH₂CH₂O)₈H (wherein n-Pr represents n-propylene)

Compound K-6: 4-n-C₉H₁₉C₆H₄—O—(CH₂CH₂O)₈H

Compound K-7: 4-n-C₁₆H₃₃O(CH₂CH₂CH₂O)₈(CH₂CH₂O)₄H

Comparative Compound H-1: 4-n-C₉H₁₉C₆H₄SO₄Na (anionic surfactant)

Comparative Compound H-2: n-C₁₆H₃₃N(CH₃)₃Br (cationic surfactant)

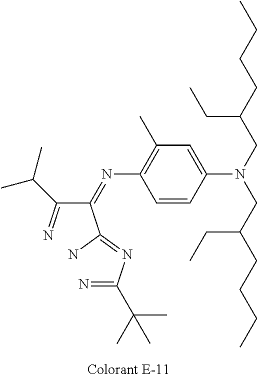 [SMILES: CCCCC(CC)CN(CC(CC)CCCC)c1ccc(/N=C(C(=N)C(C)C)\C(N)=N\C(=N)C(C)(C)C)c(C)c1]

Production of Test Cell

A glass substrate (10 mm×10 mm) having a 100-nm indium tin oxide (ITO) film as a transparent electrode is prepared, and a hydrophobic insulation film was then produced by forming a fluorocarbon polymer layer by coating a fluorocarbon polymer (Trade name: CYTOP, Grade number: CTL-809M, manufactured by Asahi Glass Co., Ltd.) to a thickness of 600 nm on the surface of the ITO film. Then, a silicone rubber wall in a picture frame shape was prepared by cutting out a square plate in a size of 8 mm×8 mm×50 μm from the center of a silicone rubber having a size of 1 cm×1 cm (a 50 μm-thick sealing material; Trade name: SILIUS, manufactured by Fuso Rubber Go., Ltd.) and was placed on the fluorocarbon polymer layer, to thereby form a display unit. In a region surrounded by the silicone rubber wall, the n-decane solution (dye ink) prepared as described above was injected to a thickness of 4 μm. Subsequently, on the injected dye ink, ethylene glycol (aqueous electrolyte solution) was injected to a thickness of 46 μm. Then, the top of the resultant product, a glass substrate having an ITO film was placed and fixed in such a manner that the ITO film faced the dye ink and the aqueous electrolyte solution, to thereby produce an electrowetting test cell having the structure shown in FIG. 1.

Evaluation

A 100 V direct voltage was applied using a signal generator to the ITO films (transparent electrodes) of the two glass substrates having an ITO film, respectively, (specifically, a negative voltage was applied to the ITO electrode on which the fluorocarbon polymer layer (hydrophobic insulation film) had been formed), and the display cell (display cell 30 in FIG. 2) was observed. It was confirmed that the dye ink moved in one direction on the surface of the fluorocarbon polymer layer, and the area on the fluorocarbon polymer layer that is covered by the dye ink reduced. Under the above conditions, the responsiveness of a dye ink and the degree of the backflow phenomenon when kept under application of a voltage were evaluated.

The reduction of the area by application of a voltage was evaluated by the area reduction rate (%) calculated by the following expression (1) and the backflow phenomenon was evaluated by the backflow rate (%) calculated by the following expression (2), respectively.

a) Response time [msec]=Time required to achieve the most reduced area from the initiation of voltage application, starting from the state without voltage application to the state in which the most reduced area was achieved.

b) Area reduction rate [%]=(Most reduced dye ink area)/(Dye ink area before voltage application)×100 Expression (1)

c) Backflow rate [%]=(Dye ink area after 5 sec of voltage application)/(Most reduced dye ink area)×100 Expression (2)

The OD (image density) was evaluated by measuring an OD value at the maximum absorption wavelength of a dye using a spectroradiometer (SR-3 (trade name), manufactured by Topcon Corporation).

TABLE 1
[Dye concentration: 40 mass %]

| | | Responsiveness | | | | | |
|---|---|---|---|---|---|---|---|
| | | Area | Response | | | | |
| | | reduction | time | | Backflow | | |
| | Surfactant | rate [%] | [msec] | | [%] | OD | Remarks |
| 1 | No | 100 | Infinite | | Unable to | 3.2 | Comparative |
| | addition | | | | evaluate | | |
| 2 | K-1 | 25 | 200 | msec or less | 110 | 3.2 | Present |
| | | | | | | | invention |
| 3 | K-2 | 48 | 200 | msec to 1 sec | 140 | 3.2 | Present |
| | | | | | | | invention |
| 4 | K-3 | 35 | 200 | msec or less | 180 | 3.2 | Present |
| | | | | | | | invention |
| 5 | K-4 | 29 | 200 | msec to 1 sec | 130 | 3.2 | Present |
| | | | | | | | invention |
| 6 | K-5 | 40 | 200 | msec or less | 150 | 3.2 | Present |
| | | | | | | | invention |
| 7 | K-6 | 60 | 1 | sec or more | 160 | 3.2 | Present |
| | | | | | | | invention |
| 8 | K-7 | 50 | 200 | msec or less | 130 | 3.2 | Present |
| | | | | | | | invention |

| | | | | | | |
|---|---|---|---|---|---|---|
| 9 | H-1 | 100 | Infinite | Unable to | 3.2 | Comparative |
| | | | | evaluate | | |
| 10 | H-2 | 100 | Infinite | Unable to | 3.2 | Comparative |
| | | | | evaluate | | |

In Table 1, an area reduction rate of 100% indicates a state without reduction.

TABLE 2
[Dye concentration: 10 mass %]

| | | Responsiveness | | | | | |
|---|---|---|---|---|---|---|---|
| | | Area | Response | | | | |
| | | reduction | time | | Backflow | | |
| | Surfactant | rate [%] | [msec] | | [%] | OD | Remarks |
| 1 | No | 22 | 200 | msec to 1 sec | 250 | 0.8 | Comparative |
| | addition | | | | | | |
| 2 | K-1 | 18 | 200 | msec or less | 110 | 0.8 | Present |
| | | | | | | | invention |
| 3 | K-2 | 25 | 200 | msec or less | 130 | 0.8 | Present |
| | | | | | | | invention |
| 4 | K-3 | 25 | 200 | msec or less | 140 | 0.8 | Present |
| | | | | | | | invention |
| 5 | K-4 | 29 | 200 | msec to 1 sec | 120 | 0.8 | Present |
| | | | | | | | invention |
| 6 | K-5 | 24 | 200 | msec or less | 150 | 0.8 | Present |
| | | | | | | | invention |
| 7 | K-6 | 22 | 200 | msec to 1 sec | 120 | 0.8 | Present |
| | | | | | | | invention |

In Table 2, an area reduction rate of 100% indicates a state without reduction.

Although there is difference in effectiveness depending on the dye concentration as shown in Table 1 and Table 2, the responsiveness was enhanced and the backflow phenomenon after an image had been displayed (in the voltage application state) was improved in the display apparatuses according to the present invention containing a nonionic surfactant in an oil (dye ink), as compared to the comparative display apparatuses containing a cationic or anionic surfactant in an oil (dye ink).

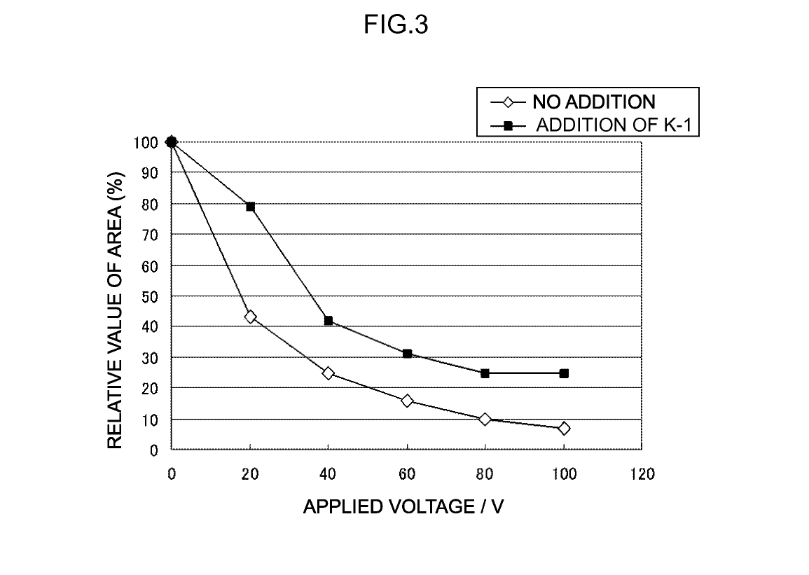

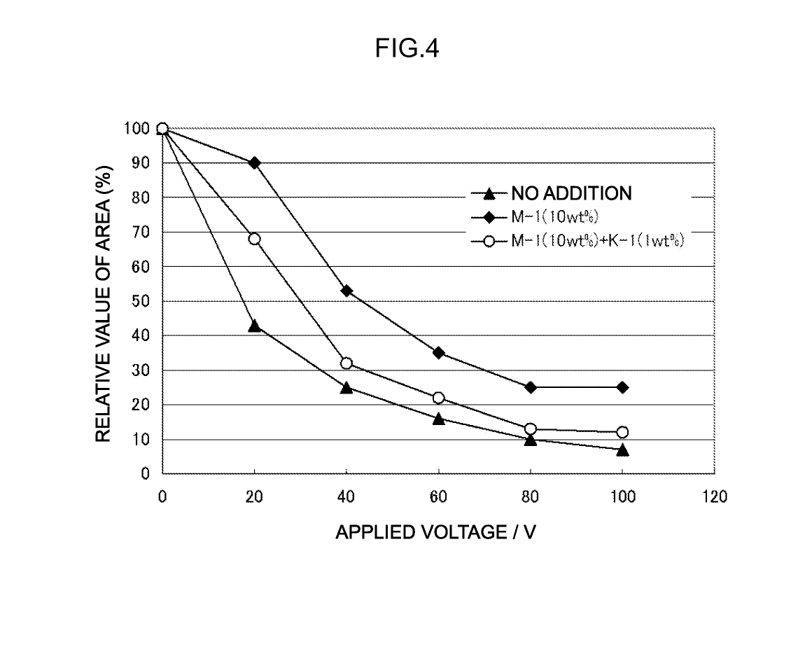

FIG. 3 shows the responsiveness in a case in which only decane was injected (represented by “⋄” in FIG. 3) and the responsiveness in a case in which a nonionic surfactant K-1 was added to decane (represented by “▪” in FIG. 3). As is obvious from FIG. 3, the responsiveness was good in a case in which only decane was added, but the responsiveness decreased when a nonionic surfactant K-1 was added. Namely, it is clear that in order to realize the same area reduction, a higher voltage is required in the presence of a nonionic surfactant. Meanwhile, as shown in FIG. 4, there is a tendency for the responsiveness to decrease when a dye is included, but this decrease in the responsiveness due to inclusion of a dye is mitigated by including a nonionic surfactant (represented by “∘” in FIG. 4). In other words, the effect of including a nonionic surfactant is evident in the presence of a dye.

Further, the enhancing effect on the responsiveness, and the improvement effect on the backflow after voltage application were more significantly evident in a composition having a higher dye concentration.

Next, a change in the interfacial tension caused by addition of a nonionic surfactant was evaluated.

The interfacial tension between ethylene glycol and an n-decane solution (dye ink) was evaluated by a pendant-drop method using an interfacial tension meter (DropMaster 500 (trade name), manufactured by Kyowa Interface Science Co., Ltd., with a hooked needle). The evaluation results are shown in the following Table 3 and Table 4.

TABLE 3
[Dye concentration: 40 mass %]

| | | Liquid-liquid interfacial | |
|---|---|---|---|
| | Surfactant | tension [mN/m] | Remarks |
| 1 | No addition | 24 | Comparative |
| 2 | K-1 | 11 | Present invention |

TABLE 4
[Dye concentration: 10 mass %]

| | | Liquid-liquid interfacial | |
|---|---|---|---|
| | Surfactant | tension [mN/m] | Remarks |
| 1 | No addition | 23 | Comparative |
| 2 | K-1 | 6 | Present invention |

As obvious from Table 3 and Table 4, the interfacial tension decreases by addition of a nonionic surfactant according to the present invention. Namely, it is presumed that the decrease in the interfacial tension is one of the factors for the enhancement of the responsiveness.

### Example 2

A dye ink was prepared, a test cell was produced, and evaluations were carried out, respectively, in the same manner as in Example 1, except that an ink having dissolved the following methine dye F-1 at 30 mass % instead of the dye E-11 in Example 1 was used. The evaluation results are shown in the following Table 5.

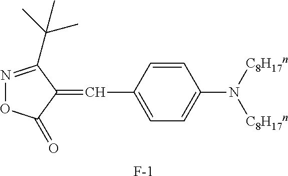

TABLE 5
[Dye concentration: 30 mass %]

| | | Responsiveness | | | | | |
|---|---|---|---|---|---|---|---|
| | | Area | Response | | | | |
| | | reduction | time | | Backflow | | |
| | Surfactant | rate [%] | [msec] | | [%] | OD | Remarks |
| 1 | No | 55 | 200 | msec to 1 sec | 180 | 1.6 | Comparative |
| | addition | | | | | | |
| 2 | K-1 | 30 | 200 | msec to 1 sec | 120 | 1.6 | Present |
| | | | | | | | invention |

In Table 5, an area reduction rate of 100% indicates a state without reduction.

As shown in Table 5, it has been confirmed that the responsiveness and the backflow were improved when the dye ink according to the present invention was used.

### Example 3

A dye ink was prepared, a test cell was produced, and evaluations were carried out, respectively, in the same manner as in Example 1, except that an ink having dissolved the following anthraquinone dye G-1 at 20 mass % instead of the dye E-11 in Example 1 was used. The evaluation results are shown in the following Table 6.

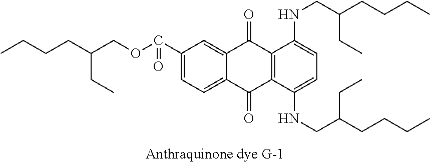 [SMILES: CCCCC(CC)CNc1ccc(NCC(CC)CCCC)c2c1C(=O)c1ccc(C(=O)OCC(CC)CCCC)cc1C2=O]

TABLE 6
[Dye concentration: 20 mass %]

| | | Responsiveness | | | | | |
|---|---|---|---|---|---|---|---|
| | | Area | Response | | | | |
| | | reduction | time | | Backflow | | |
| | Surfactant | rate [%] | [msec] | | [%] | OD | Remarks |
| 1 | No | 40 | 200 | msec to 1 sec | 220 | 0.9 | Comparative |
| | addition | | | | | | |
| 2 | K-1 | 30 | 200 | msec or less | 140 | 0.9 | Inventive |

In Table 6, an area reduction rate of 100% indicates a state without reduction.

As shown in Table 6, it has been confirmed that the responsiveness and the backflow were improved when the dye ink according to the present invention was used.

All publications, patent applications, and technical standards mentioned in this specification are herein incorporated by reference to the same extent as if each individual publication, patent application, or technical standard was specifically and individually indicated to be incorporated by reference.

What is claimed is:

1. An electrowetting display apparatus comprising a display unit, the display unit comprising:
a first substrate at least one surface of which is at least partly electroconductive;
a second substrate arranged so as to face the at least partly electroconductive surface of the first substrate;
a hydrophobic insulation film placed on at least a part of the at least partly electroconductive surface of the first substrate;
a non-electroconductive oil which is provided between the hydrophobic insulation film and the second substrate movably on the hydrophobic insulation film and comprises a nonpolar solvent, a dye at a content of 10 mass % or higher with respect to the total mass of the oil, and a nonionic surfactant; and
an electroconductive hydrophilic liquid provided between the hydrophobic insulation film and the second substrate so as to contact the oil,
wherein an image is displayed by applying a voltage between the hydrophilic liquid and the electroconductive surface of the first substrate and changing the shape of an interface between the oil and the hydrophilic liquid.

2. The electrowetting display apparatus according to claim 1, wherein the content of the dye exceeds 20 mass % with respect to the total mass of the oil.

3. The electrowetting display apparatus according to claim 1, wherein the nonionic surfactant is a compound comprising an ethyleneoxy chain or a propyleneoxy chain in a molecule thereof.

4. The electrowetting display apparatus according to claim 1, wherein the nonionic surfactant is a compound comprising an ethyleneoxy chain represented by (CH₂CH₂O)ₙ, wherein n represents an integer from 4 to 20.

5. The electrowetting display apparatus according to claim 1, wherein the dye has a structure comprising a long-chain alkyl group having 6 to 30 carbon atoms.

6. The electrowetting display apparatus according to claim 1, wherein the dye is selected from the group consisting of an azo dye, an azomethine dye, a methine dye, a phthalocyanine dye, and an anthraquinone dye.

7. A dye composition for electrowetting display, comprising:
a nonpolar solvent;
a dye at a content of 10 mass % or higher with respect to the total mass of the dye composition; and
a nonionic surfactant.

8. The dye composition for electrowetting display according to claim 7, wherein the content of the dye exceeds 20 mass % with respect to the total mass of the dye composition.

9. The dye composition for electrowetting display according to claim 7, wherein the nonionic surfactant is a compound comprising an ethyleneoxy chain or a propyleneoxy chain in a molecule thereof.

10. The dye composition for electrowetting display according to claim 7, wherein the nonionic surfactant is a compound comprising an ethyleneoxy chain represented by (CH₂CH₂O)ₙ, wherein n represents an integer from 4 to 20.

11. The dye composition for electrowetting display according to claim 7, wherein the dye has a structure comprising a long-chain alkyl group having 6 to 30 carbon atoms.
